(19) United States
(12) Patent Application Publication
(10) Pub. No.: US 2026/0079699 A1
(43) Pub. Date: Mar. 19, 2026

(54) Automated Patching for Source Code Modification

(71) Applicant: XERO LIMITED, Te Aro, Wellington (NZ)

(72) Inventor: Raice Hannay, Te Aro, Wellington (NZ)

(21) Appl. No.: 19/104,973

(22) PCT Filed: Aug. 23, 2022
(86) PCT No.: PCT/NZ2022/050109

§ 371 Date: Feb. 19, 2025

(51) Int. Cl. G06F 8/71; G06F 8/36

(52) U.S. Cl. CPC G06F 8/71; G06F 8/36

(57) ABSTRACT

A computer program executes an automated process comprising: accessing the source code of a component application within a software application composed of plural component applications, the accessed source code of the component application including an instance of template code being source code recurring at multiple component applications within the software application to implement functionality consistently across the software application and being instantiated in source code as an instance of one of plural sequential versions; maintaining a template repository comprising the plural sequential versions of the template code; determining whether or not the version of template code currently being instantiated in the source code is the most recent of the plural sequential versions, and if not, implementing one or a sequence of patches configured to target the template code to update the version of template code currently being instantiated in the source code to the most recent version.

### INTRODUCTION

Software applications may be composed of tens or hundreds of individual component applications, such as single page applications (SPAs). Much development time and budget is exhausted on seeking to provide a consistent user experience across multiple component applications within the same software application. Technical faults and bugs are caused by different component applications making inconsistent external calls and modifying data accessible to plural component applications in an inconsistent manner.

It is desired to address or ameliorate some of the disadvantages associated with such prior methods and systems, or at least to provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Embodiments include a computer program which, when executed by a computing apparatus, causes the computing apparatus to execute an automated process comprising: accessing the source code of a component application within a software application composed of plural component applications, the accessed source code of the component application including an instance of template code, template code being source code recurring at multiple component applications within the software application to implement functionality consistently across the software application and being instantiated in source code as an instance of one of plural sequential versions; maintaining a template repository comprising the plural sequential versions of the template code; determining whether or not the version of template code currently being instantiated in the source code is the most recent of the plural sequential versions, and if not, initiating an automatic source code update process comprising: implementing one or a sequence of patches configured to target the template code in the source code to update the version of template code currently being instantiated in the source code to the most recent version of the plural sequential versions from the template repository.

Optionally, if the patch or one among the sequence of patches cannot successfully update to an update target version of the patch, generating a file comprising a changeset being applied by the unsuccessful patch, and outputting to a user interface an alert notifying that the patch was unsuccessful.

Optionally, maintaining the template repository comprises storing a plurality of sequential versions of the template code, wherein preceding versions in the plurality of sequential versions are stored in association with a current most recent version among the plurality of sequential versions.

Optionally, the automatic source code update process is executable as a plugin running on a computing apparatus having read and write access to the source code or a source code project forming all or part of source code of the component application.

Optionally, upon addition of a new most recent version to the plurality of sequential versions of the template code in the template repository, the plugin is updated to reflect the new most recent version so that the automatic source code update process is executable when the new most recent version is not currently instantiated in the accessed source code, and to include or to have access to a patch or patches to update the preceding most recent version of the template code among the sequential versions to the new most recent version.

Optionally, implementing one or a sequence of patches comprises iteratively patching the detected sequential version through the sequential versions of the template code until the accessed source code is update to include the most recent of the plural sequential versions of the template code;
each patch applying a defined changeset targeting lines of a first version of the template code to update the targeted lines a second version of the template code, the second version being a sequentially next version of the template code after the first version in the plural sequential versions.

Embodiments include a computing apparatus comprising memory hardware and processor hardware, the memory hardware storing a computer program which, when executed by a computing apparatus, causes the computing apparatus to execute an automated process comprising: accessing the source code of a component application within a software application composed of plural component applications, the accessed source code of the component application including an instance of template code, template code being source code recurring at multiple component applications within the software application to implement functionality consistently across the software application and being instantiated in source code as an instance of one of plural sequential versions; maintaining a template repository comprising the plural sequential versions of the template code; determining whether or not the version of template code currently being instantiated in the source code is the most recent of the plural sequential versions, and if not, initiating an automatic source code update process comprising: implementing one or a sequence of patches configured to target the template code in the source code to update the version of template code currently being instantiated in the source code to the most recent version of the plural sequential versions from the template repository.

Embodiments include a method comprising, at a computer processor in an automated manner: accessing the source code of a component application within a software application composed of plural component applications, the accessed source code of the component application including an instance of template code, template code being source code recurring at multiple component applications within the software application to implement functionality consistently across the software application and being instantiated in source code as an instance of one of plural sequential versions; maintaining a template repository comprising the plural sequential versions of the template code; determining whether or not the version of template code currently being instantiated in the source code is the most recent of the plural sequential versions,
implementing one or a sequence of patches configured to target the template code in the source code to update the version of template code currently being instantiated in the source code to the most recent version of the plural sequential versions from the template repository.

Optionally, the software application may be a web application.

Optionally, the component applications may be single-page applications within the web application.

Template code is lines of source code, a section of source code, or a portion of one or more lines of source code, recurring at multiple component applications within the software application to implement a respective function or functions consistently across the software application. Template code may also be referred to simply as template, template code portion, boilerplate, boilerplate code, or template source code lines. Embodiments control a process of automatically updating template code appearing in a source code document or project.

Computer programs may be stored on computer-readable media. In particular, computer programs may be stored on non-transitory computer-readable media.

Advantageously, software application performance is enhanced by commonality of code for performing equivalent tasks in multiple component within the same application. Consistent behaviour between component applications belonging to the same software application improves user experience and ensures interactions between the software application and other entities such as databases and operating systems do not generate faults. Overall software application performance is enhanced by common code portions for performing equivalent functions across multiple component applications.

Embodiments leverage an automated patching technique to automate a process of updating template code to a most recent version.

### BRIEF DESCRIPTION OF DRAWINGS

Embodiments are set out in the forthcoming detailed description, by way of example, with reference to the forthcoming description in which:

FIG. 1 illustrates a process flow according to an embodiment;

FIG. 2 illustrates a process flow according to an embodiment;

FIG. 3 illustrates a schematic diagram of hardware of an embodiment;

FIG. 4 illustrates a technology stack of an embodiment; and

FIG. 5 illustrates an exemplary component application of an embodiment;

FIG. 6 illustrates a process flow according to an embodiment;

FIG. 7 is a schematic illustration of a software architecture of an embodiment;

FIG. 8 is a schematic illustration of a software architecture of an accelerator according to an embodiment;

FIG. 9 is a schematic illustration of a software architecture of an initialised project according to an embodiment;

FIG. 10 is a schematic illustration of a software architecture of a template repository according to an embodiment.

### DETAILED DESCRIPTION

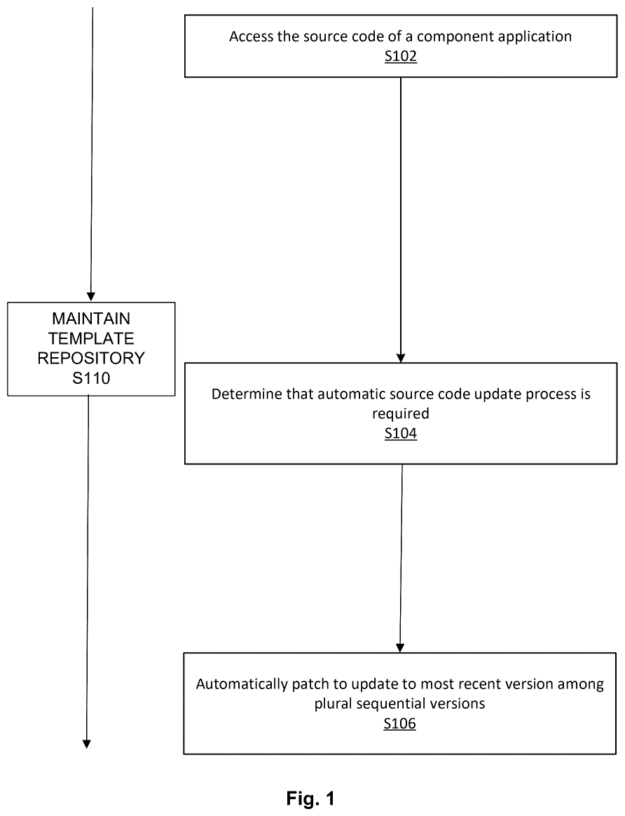

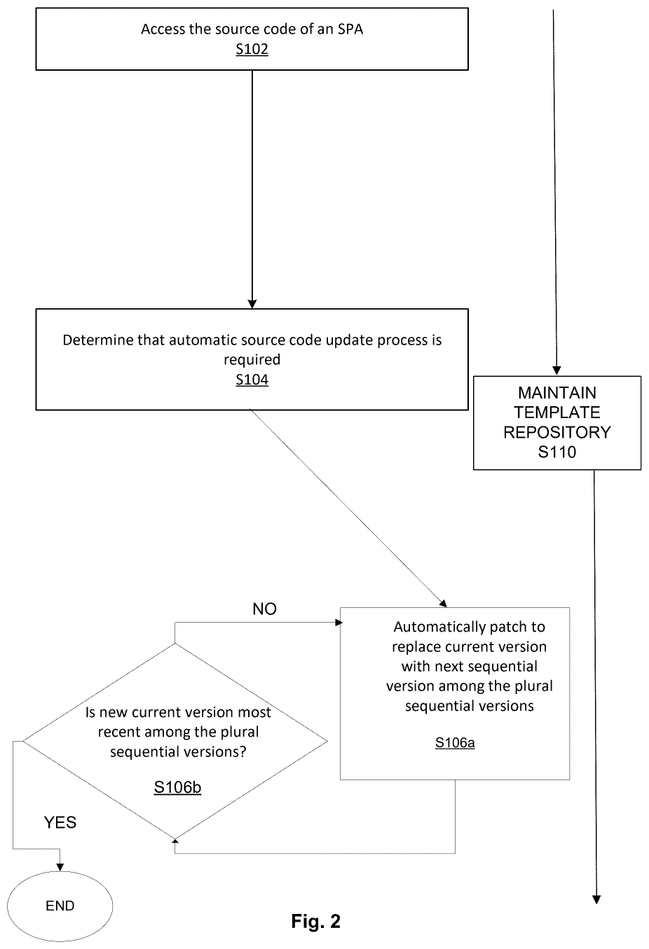

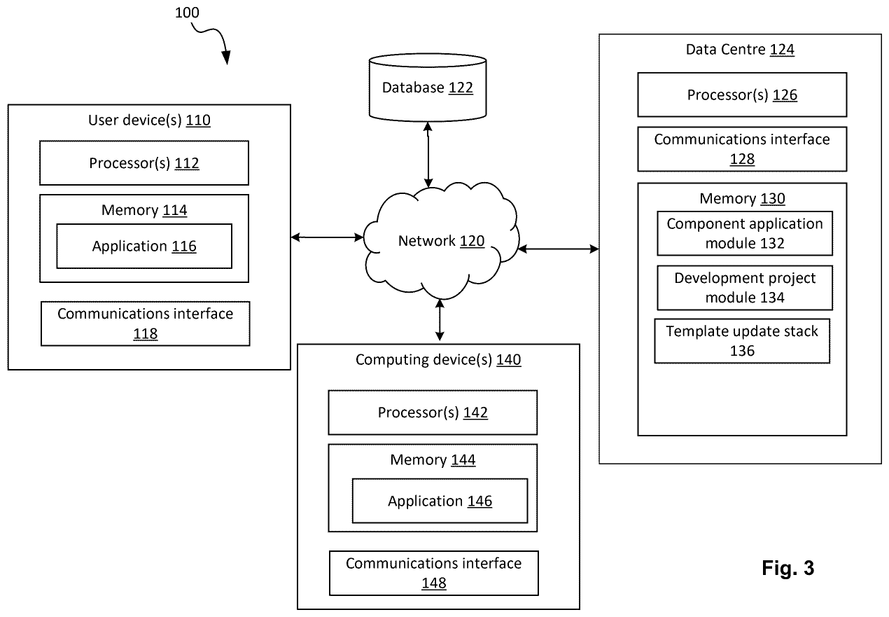

FIG. 1 illustrates a process flow according to an embodiment. FIG. 2 illustrates the same process flow with a specific example of how the step S106 may be performed. The methods illustrated by FIGS. 1 and 2 are computer-implemented methods. FIG. 3 illustrates a hardware architecture in which the process of FIGS. 1 and 2 is performed.

The process of FIGS. 1 and 2 may be performed by a computing device 140. The computing device 140 may be executing processing instructions downloaded from a data centre 124, in particular from a template update stack 136 module stored on memory hardware 130 at a data centre 124 and made available for download to developer devices via communications interface 128 of the data centre, a network 120, and a communications interface 148 of the computing device 140. The computing device 140 is, for example, a computing apparatus belonging to a software development entity and on which source code for component applications of a software application is written, reviewed, and/or manipulated. The computing device 140 is usable by an operator conducting software development activities and therefore may be referred to as a developer device 140 or a developer computing device 140. The development project module 134 is a centralised project storage module accessible to one or more developer devices 140 and storing source code, for example, for access via a document or version management interface which limits a number of developers that can access the same source code text concurrently. The term source code text is used to describe the source code for a component application, however, it is noted that the source code will not be a single file but more likely a plurality of files including, for example, a JSON file.

The term component application is used to refer to an executable software artefact forming part of a software application having functionality extending beyond that of the component application; the software application being composed of a plurality of heterogeneous component applications each performing their own functions and contributing to the overall functionality of the software application. The software application may be a web application. The component applications may be single page applications. The plural component applications of the software application are interdependent. For example, the plural component applications are configured to transfer data between one another and to access and update mutually accessible data.

It is noted that step S110 is an ongoing process running in parallel with the steps S102 to S106 (or S106b in the case of FIG. 2). Step S110 is a step of maintaining a template repository 410. Maintaining in this context includes storing and controlling access to stored template code. Controlling access may include verifying credentials of accessing entities, and responding to access requests by issuing one or more copies of template code. Embodiments leverage an automated patching technique to automate a process of updating template code in source code of component applications. Each patch applies a defined changeset, the changeset being defined to target a line or lines of code in a version of the template code currently instantiated in the source code and to update the target line or lines to conform to the next version of the template code among plural sequential versions. Each patch thus progresses the template code from one version to the next, and so by iterative automated coding the template code can be updated from any arbitrary current version to the most recent version among the plural sequential versions.

In each changeset, a target line of source code may be defined only be the line itself, or by the line and one or more adjacent lines. Advantageously, only defining the line itself reduces unsuccessful patching caused by target lines being unlocatable due to dependencies being changed adjacently to the target line. However, in some instances a changeset or patch may be configured to include adjacent lines in target line definition when required for disambiguation.

Storing template code includes storing multiple sequential versions of the template code, along with respective version number or other indicator of position of the version within the sequence. Patches update template code into source code according to a respective defined changeset. As explained above, the updating may be iterative, so that each version of a code portion is replaced by a next version in the sequence until the current most recent version has been inserted and the source code is considered up-to-date.

At step S102, the process comprises accessing the source code of a component application within a software application. Accessing may include reading, or identifying a stored location, of some or all of the source code of a component application. A component application is a software application in itself. However, in the present document the term software application is used to refer to a broader application composed of multiple interlinked component applications. An example of a software application is a web application composed of multiple single page applications, the single page applications being exemplary of component applications. A component application is dynamically rewritten with new data from a web server rather than reloading the page on the browser application of the user device to respond to user interactions. Code underlying a component application such as a single page application is loaded by the user device in a single page load. The access may be via a version management tool or a document management tool, which stores source code, and tracks changes and versions.

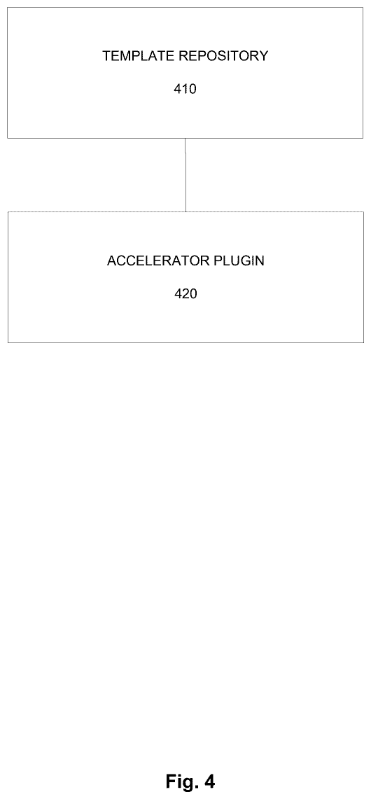

The accessed source code of the component application includes an instance of template code, template code being source code recurring at multiple component applications within the software application to implement functionality consistently across the software application. The instance of template code in the source code is one of plural sequential versions. Based on the version of the template code currently instantiated in the source code, a determination can be made at S104 as to whether or not an update is required (i.e. is the current version the most recent version, or in other words is the current version a version for which an update patch exists). Step S104 is performed at the computing device 140 that may be operated by a developer or another operative responsible for source code maintenance and upgrade, and may be performed, for example, by the accelerator plugin 420 of FIG. 4 as part of an application 146 stored by the memory 144 of the computing device 140 and executed by the processor 142. The accelerator plugin 420 is available as part of a template update technology stack as illustrated in FIG. 4 and as served to the developer device 140 by a template update stack module 136 at the data centre 124.

Template code is one or more lines of code that are common across plural component applications within the software application and so are stored and managed centrally. A Json file maps to and from different versions of template code. A current version of template code may be specified in the dependencies of a source code text, or may be otherwise specified in the accessed source code or a project or other entity to which the accessed source code belongs. JSON is JavaScript Object Notation and is a format of storing data. Embodiments store the from version as the key in the object and the to version as the value of the key, for example:

{“1.0.0”.”1.0.1”
“1.0.1”.”2.0.0”}

The term template code is used to refer to a generic sequence of versions of source code text performing equivalent functionality and iteratively manipulated, revised, and/or re-written sequentially as a number of different versions. The different versions of the same template code define a sequence, according to the chronology of their creation. Instances of template code refer to the actual code appearing in the source code of a component application. So each instance instantiates a version from among the sequence of versions of template code. Furthermore, each version of template code (other than the most recent version) is targeted in a changeset which defines target lines of source code to be replaced, and the updated lines in the next version of the plural sequential version. A patch is configured for each changeset to progress the targeted lines from one version to the next.

The template repository 410 contains the different versions of the template code within a version control system (an example of which is Git). Changesets are persisted to the template repository, wherein a changeset is defined for each version to upgrade to the next version in the sequence. A patch is created for each changeset—the patch takes the changeset descriptor and puts it in a file so that it can be applied to the accessed source code at S106. The patches are saved as part of the accelerator, for example in a storage location such as a repository, along with a version mapping file such as a JSON file.

A version mapping file may be stored as part of the accelerator 420, defining the sequential ordering of the versions relative to one another. The version mapping file may be a JSON file.

At S104, based on a current version of the template code in the source code, a starting point for the automated patching is established.

At step S104, the process comprises determining whether or not the version of template code currently instantiated in the source code is the most recent of the plural sequential versions, and if not, initiating an automatic source code update process. Alternatively, at S104 the process comprises determining whether or not a patch exists to update the version of the template code currently instantiated in the source code. Embodiments leverage an automated patching technique to iterate through the versions of the template code step-by-step from the current version in the accessed source code, up to the current most recent version from the template repository 410. Step S104 may be executed by the accelerator plugin 420 executing one or more patches. As detailed above, patch is created for each changeset—the patch takes the changeset descriptor and puts it in a file so that it can be applied to the accessed source code at S106. For example, each patch may be configured to progress through the sequence of versions of the template code by one step, that is, from one version to an immediately subsequent version in the sequence. The version instantiated in the accessed source code is a starting point for the automated patching. The accelerator plugin 420 is updated periodically with a new patch when a new version of template code is released (i.e. added to the repository 410) and so the accelerator plugin 420 is configured to determine whether or not the current version is the latest version. A new patch is configured for each new version of the template code to progress to the new most recent version in the sequence from the preceding version in the sequence. For example, the accelerator plugin 420 is configured with an indication that a latest release of template code is v5.6, and it is determined that a source code text instantiates version v4.3 of template code, so at S104 the determination is that the current version of the template code in the source code text is not the most recent among the plural sequential versions of the template code, and patches are applied to iteratively update the template code in the source code from v4.3 to v5.6.

A template repository 410 is part of the technology stack illustrated in FIG. 4. Periodically, updates to (i.e. new versions of) one or more of the template code are compiled and added to the component application template repository 410. Consequently, the accelerator plugin 420 is updated with a new patch that updates instances of the previous current version of the template code to the respective new versions thereof. The accelerator plugin 420 is the element of the stack that runs on the developer device and executes the patch on the source code text to initiate the automatic source code update. Embodiments implement an automated patching technique to iterate through versions of template code from an arbitrary version present in some subject source code to the most recent version.

The automatic source code update process comprises: executing one or more patches stored in the accelerator 420. Each patch applies a changeset defined to iterate from one version of the respective template code to the next version of the respective template code among the plural sequential versions. The patches execute iteratively progressing by one version among the plural sequential versions at a time until the current version in the accessed source code is the most recent among the plural sequential versions. Thereby, the function of S106 is to replace the out-of-date version of the template code present in the accessed source code at S102, with a most recent version among the plural sequential versions of the template code stored by the template repository 410, via automated application of patches stored by the accelerator plugin 420. S106 comprises retrieving and implementing a patch configured to replace the current version of the template code with a most recent version of the plural sequential versions.

FIG. 3 illustrates a particular automated patching mechanism which is based upon patches that are each configured, for each version of template code, to update from the said version to a next version among the plural sequential versions. For example, each patch applies a changeset defined to progress from a given version to the version proceeding the given version among the plural sequential versions. In this regard, the patches themselves, and indeed the changesets, may be considered to define a sequence.

It is feasible in some cases that the patching may not execute correctly and may not be able to apply the relevant defined changeset. This may be the case when the developer modified the relevant source code from its released form, so that, even if it is evident from the dependencies that a particular version of the template code is present in the source code, the target lines (defined by a changeset updating from the said particular version to a next version) which are to be updated cannot be located in the automated patching process S106. For example, an error message may be added to a register alerting a developer of the version of the template code in the update that failed. For example, the process may comprise, if the patch cannot successfully execute the update from one version to the next, generating a file (which may be saved as a .rej or reject file) comprising the changeset being applied by the unsuccessful patch, and alerting the user via a user interface, such as the command line interface, that the patch failed and instructing the user to manually make the changes contained within the file before proceeding.

Step S106 (or S106a & S106b, as appropriate) may be executed by the accelerator plugin 420, for example, running an automated patching process. Embodiments may comprise a sequence of patches, wherein each patch is configured to update the template code from a respective version currently in the source code to the next version in the sequence. For example, a changeset may be defined defining the code modifications from the respective one version to the next version, which changeset is applied by the patch. Therefore, by executing one or a sequence of patches, the template code is iteratively updated to the most recent version via each interim version in the plural sequential versions. Alternatively, multiple patches may be configured to update directly to the most recent version directly from any preceding version.

FIG. 2 illustrates a particular example of the automated patching process of step S106. According to FIG. 2, step S106 is divided into steps S106a, wherein the automated patching follows an iterative loop in which at S106a the patching progresses each version to its respective next sequential version among the plural sequential versions, and at S106b, a check is performed to verify that the new current version (resulting from the patch executed in the most recent iteration of S106a) in the source code is the most recent version from the template repository. A mapping file may be maintained in the accelerator plugin 420 for this purpose. In the embodiment of FIG. 2, a patch exists for each released version of the template code preceding the most recent version (i.e. for each of the earliest n−1 versions among a plural of n sequential versions) to patch to the version from the preceding version in the sequence. The patches are part of the accelerator 420 and are administered to the source code text by the accelerator plugin 420 in an automated manner, so that the updating of the template code runs independently of manual input (once the project is initialised). A patch applies a defined changeset to replace a defined version of template code with a defined new version of the template code.

At S106b, once the update from one version to the next version among the plural sequential versions has been executed, a determination is made of whether the current version (i.e. the version that the code was updated to at the most recent iteration of S106a) is the most recent version in the sequence. If it is, then the process ends because no further update can be performed. If it is not, the flow returns to S106a and the next patch is executed, i.e. the patch to replace the version of the template code currently in the source code text (after the previous iteration of S106a) to the respective next version among the plural sequential versions.

The patches are stored as part of the accelerator 420 and are each configured to progress a particular version of template code to the next version. For example, the patch identifies a line of code to be replaced or otherwise updated may in some cases also identify at least a line of code before and/or after the line to be replaced or otherwise updated (which in some cases is required for disambiguation). The lines before and after assist in accurate identification in some cases, for example if disambiguation is required. However, the identifying may rely solely on identifying the line or other defined portion of existing code that is to be replaced irrespective of what lines of code are before and after.

An exemplary system architecture is illustrated in FIG. 3, and will be discussed in more detail below. Embodiments such as illustrated in FIGS. 1, 2, and 4, are platform agnostic and can run on all operating systems. The accelerator 420 integrates with a version control system such as Git, which version control system itself uses a network to pull code, and uses a Node Package Manager for its dependencies (and also uses the network to download dependencies). Plus the accelerator may use Node.js to run the command line interface to access the file system of the relevant computing device.

FIG. 3 is a block diagram of system 100 for developing component application software for a software application using the automated source code update technology of embodiments such as illustrated by FIGS. 1 and 2. The system 100 of FIG. 1 provides means for implementing the method illustrated in process flow diagrams FIGS. 1, 2, and means for serving and executing the technology stack of FIG. 4 (via template update stack module 136).

As illustrated, the system 100 may comprise one or more from among: user device(s) 110, external database 122, data centre 124, one or more computing devices 140. The data centre 124 is one or more server computers. The server computers are illustrated as belonging to the same data centre 124 apparatus. The functionality of the component application module 132 is as a web server serving component applications to the user device 110 via the communications interface of the data centre 128 to the communications interface of the user device 110 via the network 120. Said functionality may be provided entirely independently of the template update stack module 136 and the development project module 134, since these modules relate to software development functions and therefore are internal to a software application provider. Thus, for example, the software application provider may use a separate set of servers for implementing modules 134 and 136 than are used for module 132. Hence, the illustration of a single memory 130 is not to be interpreted as limiting the three illustrated modules to being stored on the same memory hardware or memory hardware of a particular server or data centre, but merely to illustrate that they are all functional modules of servers.

User device 110 may comprise a mobile or handheld computing device such as a smartphone or tablet, a laptop, or a PC, and may, in some embodiments, comprise multiple computing devices. The user device 110 may comprise one or more processor(s) 112, memory 114 and/or communications interface 118. The processor(s) 112 may comprise one or more microprocessors, central processing units (CPUs), application specific instruction set processors (ASIPs), application specific integrated circuits (ASICs) or other processors capable of reading and executing instruction code. The processor(s) 112 may be configured to receive stored instructions (i.e. program code) from memory 114, which when executed by the processor(s) 112 may cause the user device 110 to function according to the described embodiments. Client device 110 comprises one or more display screens, the or each of the one or more display screens being configured to display the component applications served by the component application module 132 and developed by the developer device 140 using the technology stack of FIG. 4 and following the process of FIG. 1 or 2. Wherein functionality determining arrangement and content of the component application is provided by the processor hardware 112, and the memory hardware 114, which may be cooperating with data centre 124 and obtaining data from an external database 122. The component application is served to the user device 110 by the component application module 132 of the data centre 124 as part of a software application of interdependent component applications. The component application, once loaded, is an application 116 stored on the memory 114, or part of an application 116 stored on the memory 114.

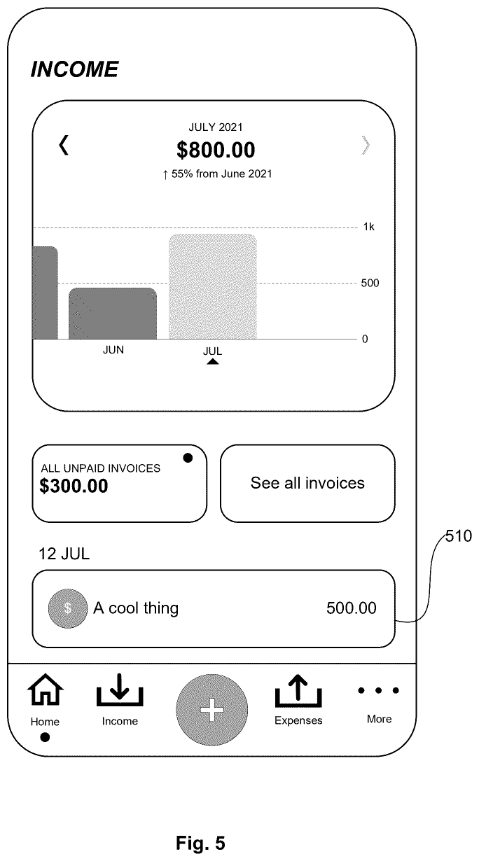

The memory 114 may comprise component application 116 which comprises computer executable code, which when executed by the one or more processors 112, is configured to allow user device 110 to run the component application as exemplified in FIG. 5, which component application is a single page application. The communications interface 118 facilitates communications with components of the communications interface 118 across the network 120, such as: database 122, data centre 124. The communications interface 118 may comprise a combination of network interface hardware and network interface software suitable for establishing, maintaining and facilitating communication over a relevant communication channel.

Computing device 140 may comprise a mobile or handheld computing device such as a smartphone or tablet, a laptop, or a PC, and may, in some embodiments, comprise multiple computing devices. The computing device 140 may comprise one or more processor(s) 142, memory 144 and/or communications interface 148. The processor(s) 142 may comprise one or more microprocessors, central processing units (CPUs), application specific instruction set processors (ASIPs), application specific integrated circuits (ASICs) or other processors capable of reading and executing instruction code. The processor(s) 142 may be configured to receive stored instructions (i.e. program code) from memory 144, which when executed by the processor(s) 142 may cause the computing device 140 to function according to the described embodiments. Computing device 140 comprises one or more display screens. Computing device 140 may be operated by a software developer configuring source code for a component application forming part of a software application, to be served by component application module 132. The computing device 140 accesses source code to configure from a development project module 134 at the network 120 and in exchange for user credentials is authorised to make read and write access to stored source code texts. The computing device 140 downloads the template repository of FIG. 4 from the template update stack module 136, and executes the accelerator plugin 420 via a command line or other application or interface. In so doing, the developer device initiates a process set out in FIGS. 1 and 2 to execute on the developer device 140, optionally in concert with one or more modules of the data centre 124.

The network 120 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 120 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The database 122 may form part of or be local to the system 100, or may be remote from and accessible to the system 100, for example, via the communications network 120. The database 120 may be configured to store data associated with the system 100. The database 120 may be a centralised database. The database 120 may be a mutable data structure. The database 120 may be a shared data structure. The database 120 may be a data structure supported by database systems such as one or more of PostgreSQL, MongoDB, and/or ElasticSearch. The database 120 may be configured to store a current state of information or current values associated with various attributes (e.g., “current knowledge”). For example,

Data centre 124 may comprise one or more web servers configured to serve component applications to the user device 110. Component applications are exemplified in FIG. 5 by a single page application.

In some embodiments, data centre 124 may comprise one or more processors 126 and memory 130 storing instructions (e.g. program code) which when executed by the processor(s) 126 causes the system 100 to serve the template update stack of FIG. 4 to a developer device and/or to serve a component application implementing source code configured by the template update stack to a user device 110. The processor(s) 126 may comprise one or more microprocessors, central processing units (CPUs), application specific instruction set processors (ASIPs), application specific integrated circuits (ASICs) or other processors capable of reading and executing instruction code.

In some embodiments, the data centre 124 may operate in conjunction with or support one or more external devices, such as user device 110, database 122, developer device 140, to manage the provision of and development of component applications within a broader software application.

The memory 130 may comprise one or more volatile or non-volatile memory types. For example, memory 130 may comprise one or more of random access memory (RAM), read-only memory (ROM), electrically erasable programmable read-only memory (EEPROM) or flash memory. Memory 130 is configured to store program code accessible by the processor(s) 126. The program code comprises executable program code modules. In other words, memory 130 is configured to store executable code modules configured to be executable by the processor(s) 126. The executable code modules, when executed by the processor(s) 126 cause the system 100 to perform the functionality according to the described embodiments, as described in more detail below. Memory 130 may comprise component application module 132, which stores and serves component applications (such as SPAs) to user devices. Development project module 134, which may, for example, store and control access to source code of component applications. Template update stack module 136 which stores a technology stack such as that illustrated by FIG. 4 for serving to computing devices 140 for configuring source code of component applications.

The component application may be part of an accounting system. The accounting system may comprise one or more computing devices and/or server devices, such as one or more servers, databases, and/or processing devices in communication over a network. The accounting system may be configured to provide accounting services to users, such as entities and accounts, and to maintain accounts for a plurality of entities, such as businesses, individuals and organisations. For example, the accounting system may be used by an accounting services provider such as an accountant, and used to track payer data and invoice data generated with respect to clients of the accounting services provider, such as business entities.

According to some embodiments, the accounting system may comprise a cloud based server system. The accounting system may further comprise a processor in communication with a memory. The processor may comprise one or more data processors for executing instructions, and may comprise one or more microprocessor based platforms, central processing units (CPUs), application specific instruction set processors (ASIPs), application specific integrated circuits (ASICs), suitable integrated circuits, or other processors capable of fetching and executing instruction code as stored in the memory. The processor (not shown) may include an arithmetic logic unit (ALU) for mathematical and/or logical execution of instructions, such as operations performed on the data stored in internal registers of the processor.

The accounting system may be configured to receive and/or store data related to one or more invoices issued by an entity to a client or customer. Invoice data may include a unique invoice identifier, such as an invoice number. Invoice data may also include one or more of a payment date, payment deadline, payment amount, discount amount, tax amount and unique client or invoice identifier. The unique client identifier may include one or more of the client name, client contact information such as a telephone number, a company registration number (such as an ABN or ACN) or a number generated by the accounting system 231 to uniquely identify the client.

The accounting system may also be configured to store data relating to payers associated with the business entity, such as clients and customers to whom invoices are issued. Payer data may include one or more of the payer name, payer contact information such as a telephone number, a company registration number (such as an ABN or ACN) or a payer identifier such as a payer account number.

FIG. 5 illustrates an exemplary component application. In the example of FIG. 5, the software application is an online bookkeeping service forming part of an accounting system. The component application provides an interface for navigating income and expenses on a monthly basis and comparing monthly totals as a time series viewable on a bar chart. For example, template code may be employed to realise functionality generic to multiple component applications among the software application. Examples may include retrieving individual transactions from an external database for representation in a frame 510. Template code may be configured to query and store locally the income transactions satisfying a particular time filter. It can be appreciated that functionality is enhanced and incorrect or faulty queries to the database are avoided by using template code for the purpose. Distinct lines of template code may be configured to transform a stored version of a transaction into a version for display, for example extracting information for inclusion in a label and determining how to render the icon. It can be appreciated that user experience is enhanced by consistency across component applications of the equivalent functionality.

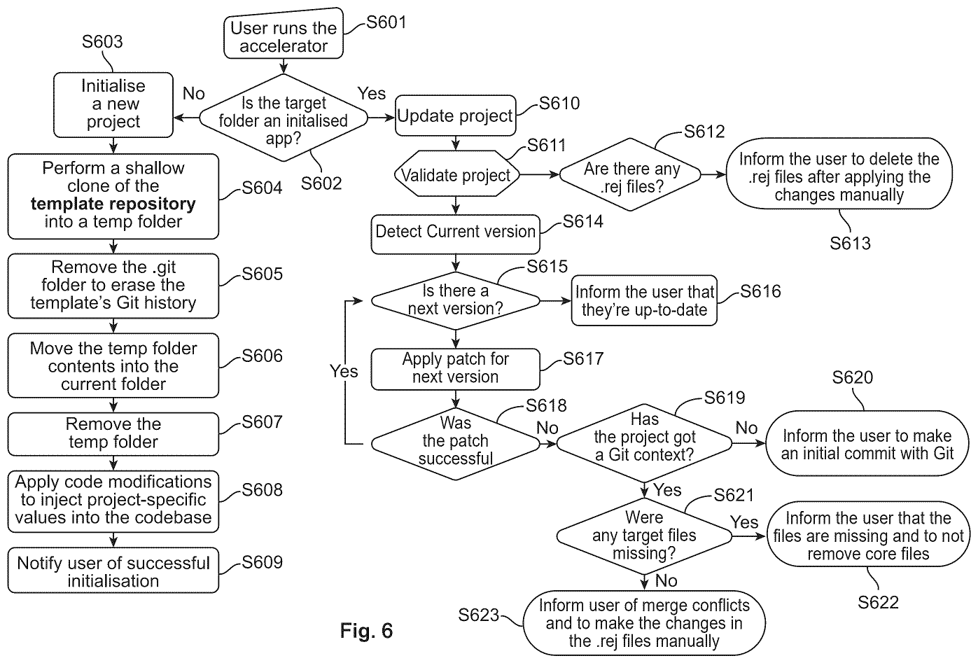

FIG. 6 illustrates a processing flow in a method, program, or computing apparatus. At step S601 user, such as a software developer or another user responsible for maintaining source code of a component application, runs the accelerator 420. The user may be required, via prompts output to an interface or otherwise, to input one or more arguments or input parameters to a user interface such as a command line interface, CLI, to run the accelerator 420. For example, the user may be requested to indicate a target folder in which source code of a component application is stored. At S602 a check is made by the accelerator 420 to determine whether the target folder is an initialised application. If false, the flow proceeds to S603, if true, the flow proceeds to S610.

At S603, a new project 700 is initialised by the accelerator 420.

The flow proceeds to S604 at which a shallow clone of the template repository 410 is performed into a temporary folder.

Embodiments leverage a version control system. In the example of FIG. 6, the version control system is git, however embodiments are not limited to any specific version control system. At S605 an existing .git folder is removed from the project to erase the .git history of the template. At S606 the temp folder contents are moved into a current folder of the initialised project 700 and at S607 the temp folder removed. At S608 code modifications are applied to insert project-specific values into the codebase. At S609 a user is informed of successful initialisation. Steps S603 to S609 are executed by the accelerator 420. The accelerator proceeds to S610 either automatically or by prompting the user to re-run the accelerator 420.

At S610 the template code of the codebase is updated by the accelerator 420 in steps S611 to S623.

At S611 the project is validated, including a check at S612 as to whether there are any pending .rej (that is, reject files indicating update failures from previous update procedures). If yes, then an alert is output to the user via the command line interface or another user interface to inform the user to either action the .rej file (which may comprise performing manual changes to alleviate a merging conflict) or to delete the .rej file. It is noted that deleting the .rej file without taking appropriate action will lead to the same .rej file being generated in the present project upgrade S610. The .rej file is exemplary of a file composed by a processor in response to unsuccessful application of a patch. The file may comprise the changeset that the unsuccessful patch is configured to apply.

Steps S610 to S623 are performed by the accelerator 420.

At S614 current version of any template code portions instantiated in the codebase of the subject project is detected or otherwise determined or obtained. At S615 a check is performed against the template repository 410 (or information cataloguing or otherwise representing content of the template repository 410) as to whether the current version is the latest version, or whether a next version exists.

If there is no next version, and so the version currently in the source code is the latest version, then a message may be output at S616 to inform the user that the source code is up to date.

For any template code for which the version present in the source code is not the most recent version in the template repository 410, a patch is applied at S617 to progress the template code through the sequence of versions by one version at a time. At S618 a check is performed as to whether the patch was successful, and if not the flow proceeds to S619.

At S619 a check is performed as the whether the project has a context in the version control software. If not, the flow proceeds to S620 and the user is informed via the command line interface or another user interface to make an initial commit with the version control software.

At S621 a check is performed as to whether any target files were missing. If so, the flow proceeds to S622 and the user is informed via the command line interface or another user interface that files are missing and may be notified not to remove core files. If no target files were missing, the flow proceeds to S623 and the user is informed via the command line interface or another user interface that there are merge conflicts and that a .rej file has been generated with instructions regarding the manual changes required, for example in the form of the changeset that was being implemented in the unsuccessful patch.

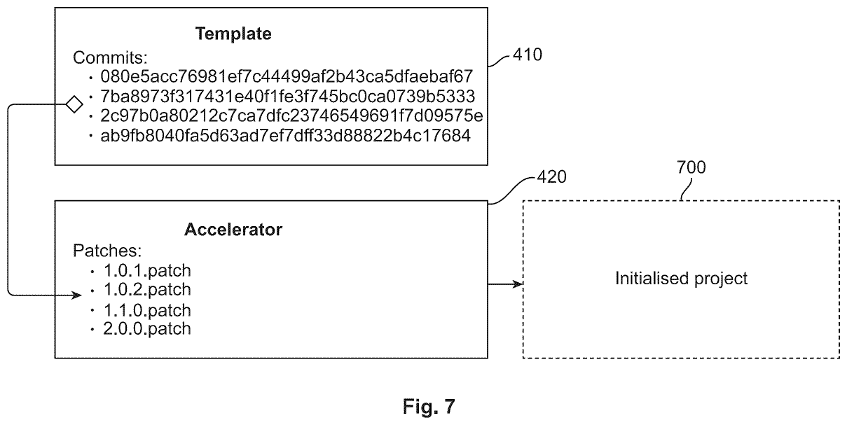

FIG. 7 is a schematic illustration of software implementing methods described herein and as illustrated in FIGS. 1, 2, and 6.

As illustrated in FIG. 7, the software includes a template repository 410 and an accelerator 420. Each of the template repository 410 and the accelerator 420 comprises stored data including processing instructions, and execution of the stored processing instructions in association with processor hardware results in the functionality of the respective component being realised. The software may be stored on a computer readable storage medium such as a non-transitory computer-readable storage medium. The template repository 410 and the accelerator 420 are functional modules, noting that the primary function of the template repository 410 is to store templates, and the primary function of the accelerator 420 is to apply the stored templates to projects.

Commits are made to the template repository 410 via a version control system. Examples of version control systems that embodiments may leverage include Git, Azure DevOps Server, Helix Core, AWS CodeCommit, Subversion, Rational ClearCase, Mercurial, Plastic SCM, and Micro Focus AccuRev.

As illustrated by FIG. 7, a hash of commits may be recorded in the template repository 410.

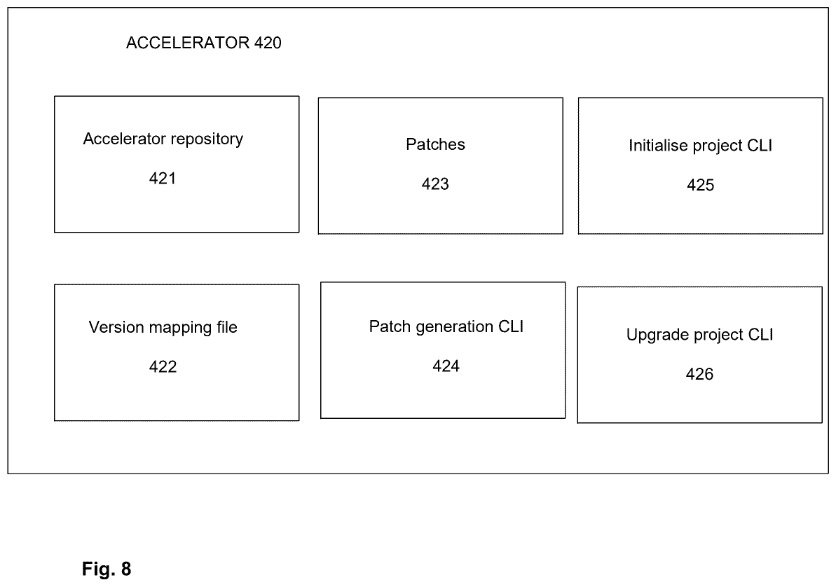

A schematic diagram of an exemplary accelerator 420 is illustrated in FIG. 8. The accelerator 420 comprises one or more functional and stored data components from among: an accelerator repository 421, a version mapping file 422, patches 423, patch generation command line interface 424, initialise project command line interface 425, and upgrade project command line interface 426. Each of the components illustrated in FIG. 8 comprises stored data including processing instructions, and execution of the stored processing instructions in association with processor hardware results in the functionality of the respective component being realised. The software may be stored on a computer readable storage medium such as a non-transitory computer-readable storage medium. The accelerator repository 421, a version mapping file 422, patches 423, patch generation command line interface 424, initialise project command line interface 425, and upgrade project command line interface 426, are functional modules.

The accelerator repository 421 contains automation logic for initialising new projects, as well as applying patches to keep the initialised project 700 up-to-date. The accelerator repository 421 may also contain the generated patches, the patch generation command line interface 424, the patches 423, and the version mapping file 422.

The version mapping file 422 may be a JSON file. The JSON file may be a flat object wherein the property key is the “from” version information and the value is the “to” version information (i.e. in a key value store), to define an upgrade path. For example:

{
“1.0.0”, “1.0.1”
}

The patch generation command line interface 424 may be a command line interface script that is configured to collect information from a user (for example a software engineer) via the command line interface in order to generate a patch from the template repository's commit(s), which will be compatible with the initialised project 700.

It is noted that in patch generation CLI 424, initialise project CLI 425, and upgrade project CLI 426, the command line interface is an example of an interface by which the accelerator 420 may receive user inputs to configure its processing. However, other user interfaces may be implemented. The command line interface is provided as an example. For example, one or more dedicated user interfaces may be included as part of the accelerator 420 or other software implementing the methods of FIGS. 1, 2, and 6.

The patches 423 are patches such as patch entities in a version control system. The patches 423 may be generated from commit changesets in the template repository 410.

The initialise project command line interface 425 is a command line interface script configured to initiailise a new project 700 by performing a shallow clone of the template repository 410, removing the version control system history, and applying some code modification to insert project-specific values into the codebase.

The upgrade project CLI 426 is a command line interface script that will iterate through the version mapping file 422 starting at the current version and automatically applying each patch 423 in sequence. If a merge conflict is encountered, the script will stop and generate rejection files instructing the user to manually apply the rejected changes. The rejection file is exemplary of a file composed by a processor in response to unsuccessful application of a patch. The file may comprise the changeset that the unsuccessful patch is configured to apply.

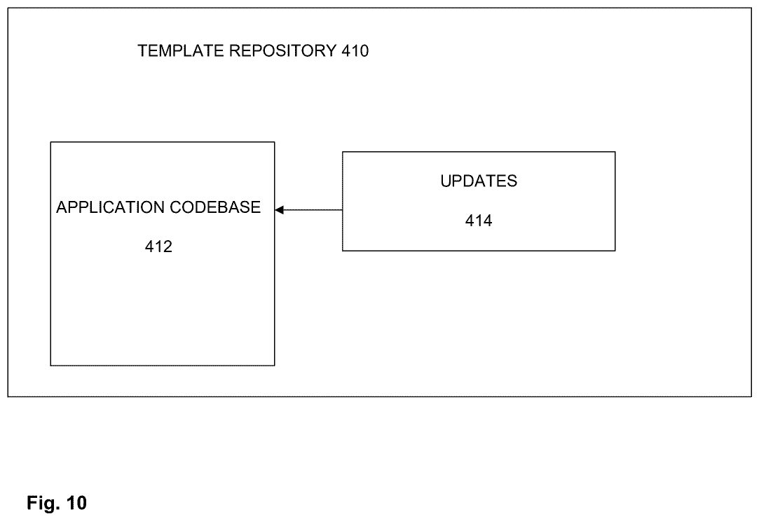

A schematic of the template repository 410 is illustrated in FIG. 10. The template repository 410 comprises an application codebase 412 which may be updated by updates 414. The template repository 410 is a working project that can be run, with full test coverage. The template repository 410 does not use any templating language and is just the actual code portions, which allows it to be run/tested effectively.

The application codebase 412 is a fully operational application codebase which is cloned when the accelerator 420 is executed to initialise a new project 700.

Updates 414 to the codebase 412 may be contained in version control system commits. The accelerator 420 in turn is configured to use the committed updates to generate patches 423 to apply to initialised projects 700.

The initialised project 700 is an entity generated by the accelerator 420 and is an artefact resulting from the execution of the accelerator 420 in cooperation with data stored in the template 410.

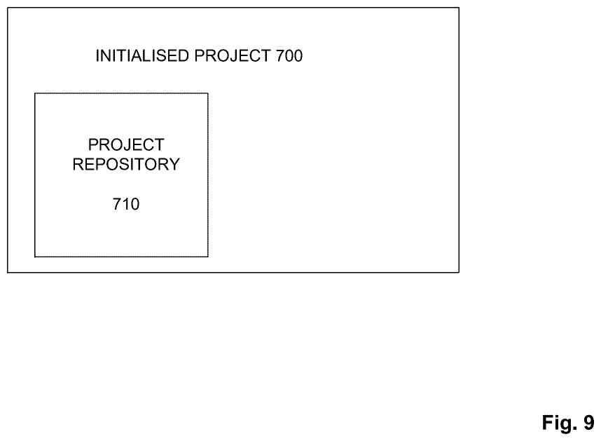

The initialised project 700 and the component elements thereof are illustrated in FIG. 9. The initialised project 700 comprises a project repository 710.

A project repository 710 is a repository for the initialised project 700.

The initialised project 700 is the resulting codebase that the accelerator 420 generates from the template 410. It is an entirely new separate repository. In order to keep the common files that the template 410 provided in sync, the accelerator 420 is executed to apply patches to the codebase in the initialised project 700.

An initialised project 700 initialised by the accelerator 420 is effectively a consumer of the accelerator. In other words, the initialised project 700 is not a functional aspect of the template code replacement technology illustrated in FIGS. 1 to 7, but rather consumes or receives or is otherwise modified by patches issued, provided, or otherwise output by the accelerator 420 in order to stay up-to-date with upstream change in the template 410.

With respect to compatibility of codebase with patches, it is noted that code engineers may minimise risk of merge conflicts by refraining from significantly modifying or deleting files that are provided by the template 410.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A non-transitory computer-readable medium storing a computer program which, when executed by a computing apparatus including a processor, causes the processor to execute an automated process comprising:
accessing a source code of a component application within a software application composed of plural component applications, the accessed source code of the component application including an instance of template code, template code-being source code recurring at multiple component applications within the software application to implement functionality consistently across the software application and being instantiated in source code as an instance of one of plural sequential versions;
maintaining a template repository comprising the plural sequential versions of the template code; and
determining whether or not the version of template code currently being instantiated in the source code is the most recent of the plural sequential versions, and if not, initiating an automatic source code update process comprising:
implementing one or a sequence of patches configured to target the template code in the source code to update the version of template code currently being instantiated in the source code to the most recent version of the plural sequential versions from the template repository.

2. The non-transitory computer-readable medium according to claim 1, further comprising:
if the patch or one among the sequence of patches cannot successfully update to an update target version of the patch, generating a file comprising a changeset being applied by an unsuccessful patch, and outputting to a user interface an alert notifying that the patch was unsuccessful.

3. The non-transitory computer-readable medium according to claim 1, wherein maintaining the template repository comprises storing a plurality of sequential versions of the template code, wherein preceding versions in the plurality of sequential versions are stored in association with a current most recent version among the plurality of sequential versions.

4. The non-transitory computer-readable medium according to claim 1, wherein the automatic source code update process is executable as a plugin running on a computing apparatus having read and write access to the source code or a source code project forming all or part of source code of the component application.

5. The non-transitory computer-readable medium according to claim 3, wherein, upon addition of a new most recent version to the plurality of sequential versions of the template code in the template repository, a plugin is updated to reflect the new most recent version so that the automatic source code update process is executable when the new most recent version is not currently instantiated in the accessed source code, and to include or to have access to a patch or patches to update a preceding most recent version of the template code among the sequential versions to the new most recent version.

6. The non-transitory computer-readable medium according to claim 1, wherein implementing one or a sequence of patches comprises iteratively patching a detected sequential version through the sequential versions of the template code until the accessed source code is updated to include the most recent of the plural sequential versions of the template code,
each patch applying a defined changeset targeting lines of a first version of the template code to update the targeted lines to a second version of the template code, the second version being a sequentially next version of the template code after the first version in the plural sequential versions.

7. (canceled)

8. (canceled)

9. (canceled)

10. A method comprising, at a computer processor in an automated manner:
accessing a source code of a component application within a software application composed of plural component applications, the accessed source code of the component application including an instance of template code, the template code being source code recurring at multiple component applications within the software application to implement functionality consistently across the software application and being instantiated in source code as an instance of one of plural sequential versions;
maintaining a template repository comprising the plural sequential versions of the template code;
determining whether or not the version of template code currently being instantiated in the source code is the most recent of the plural sequential versions; and
implementing one or a sequence of patches configured to target the template code in the source code to update the version of template code currently being instantiated in the source code to the most recent version of the plural sequential versions from the template repository.

11. The method according to claim 10, further comprising:
if the patch or one among the sequence of patches cannot successfully update to an update target version of the patch, generating a file comprising a changeset being applied by an unsuccessful patch, and outputting to a user interface an alert notifying that the patch was unsuccessful.

12. The method according to claim 10, wherein:
maintaining the template repository comprises storing a plurality of sequential versions of the template code, wherein preceding versions in the plurality of sequential versions are stored in association with a current most recent version among the plurality of sequential versions.

13. The method according to claim 10, wherein the method is executable as a plugin running on a computing apparatus having read and write access to the source code or a source code project forming all or part of source code of the component application.

14. The method according to claim 12, wherein, upon addition of a new most recent version to the plurality of sequential versions of the template code in the template repository, a plugin is updated to reflect the new most recent version so that an automatic source code update process is executable when the new most recent version is not currently instantiated in the accessed source code, and to include or to have access to a patch or patches to update a preceding most recent version of the template code among the sequential versions to the new most recent version.

15. The method according to claim 10,
wherein implementing one or a sequence of patches comprises iteratively patching a detected sequential version through the sequential versions of the template code until the accessed source code is updated to include the most recent of the plural sequential versions of the template code,
each patch applying a defined changeset targeting lines of a first version of the template code to update the targeted lines a second version of the template code, the second version being a sequentially next version of the template code after the first version in the plural sequential versions.

16. A computing apparatus including a memory and a processor, the memory storing processing instructions which, when executed, cause the processor to execute an automated process comprising:
accessing a source code of a component application within a software application composed of plural component applications, the accessed source code of the component application including an instance of template code, template code being source code recurring at multiple component applications within the software application to implement functionality consistently across the software application and being instantiated in source code as an instance of one of plural sequential versions;
maintaining a template repository comprising the plural sequential versions of the template code; and
determining whether or not the version of template code currently being instantiated in the source code is the most recent of the plural sequential versions, and if not, initiating an automatic source code update process comprising:
implementing one or a sequence of patches configured to target the template code in the source code to update the version of template code currently being instantiated in the source code to the most recent version of the plural sequential versions from the template repository.

17. The computing apparatus according to claim 16, wherein the automated process further comprises:
if the patch or one among the sequence of patches cannot successfully update to an update target version of the patch, generating a file comprising a changeset being applied by an unsuccessful patch, and outputting to a user interface an alert notifying that the patch was unsuccessful.

18. The computing apparatus according to claim 16, wherein maintaining the template repository comprises storing a plurality of sequential versions of the template code, wherein preceding versions in the plurality of sequential versions are stored in association with a current most recent version among the plurality of sequential versions.

19. The computing apparatus according to claim 16, wherein the automatic source code update process is executable as a plugin running on a computing apparatus having read and write access to the source code or a source code project forming all or part of source code of the component application.

20. The computing apparatus according to claim 18, wherein, upon addition of a new most recent version to the plurality of sequential versions of the template code in the template repository, a plugin is updated to reflect the new most recent version so that the automatic source code update process is executable when the new most recent version is not currently instantiated in the accessed source code, and to include or to have access to a patch or patches to update a preceding most recent version of the template code among the sequential versions to the new most recent version.

21. The computing apparatus according to claim 16, wherein implementing one or a sequence of patches comprises iteratively patching a detected sequential version through the sequential versions of the template code until the accessed source code is updated to include the most recent of the plural sequential versions of the template code,
each patch applying a defined changeset targeting lines of a first version of the template code to update the targeted lines a second version of the template code, the second version being a sequentially next version of the template code after the first version in the plural sequential versions.
